(19) United States
(12) Patent Application Publication
(10) Pub. No.: US 2011/0116785 A1
(43) Pub. Date: May 19, 2011

(54) DEVICE FOR OPENING AND CLOSING CAMERA DOOR

(75) Inventors: Young Pyo Lee, Ansan-city (KR); Hyun Cheal Bang, Ansan-city (KR); Sang Hoo Kim, Ansan-city (KR)

(73) Assignee: HYSONIC CO., LTD., Ansan-city (KR)

(21) Appl. No.: 13/002,669

(22) PCT Filed: Nov. 23, 2009
(86) PCT No.: PCT/KR09/06895

§ 371 Date: Jan. 5, 2011

(30) Foreign Application Priority Data
Nov. 25, 2008 (KR) 10-2008-0117409

(51) Int. Cl. G03B 17/02

(52) U.S. Cl. 396/535

(57) ABSTRACT

Provided is an apparatus for opening and closing a camera door, which can automatically open and close a lens of a camera installed at a mobile phone and the like. The apparatus for opening and closing a camera door, includes a base which is formed with an opening portion and disposed at a front surface of a lens; a rotational shaft; a driving part for rotating the rotational shaft; and a door of which one end encloses the rotational shaft so as to slide along the rotational shaft and thus to open and close the opening portion, wherein a male screw thread is formed on an outer surface of the rotational shaft, and a female screw thread is formed on an inner surface of other end of the door so as to be engaged with the male screw thread, and the door is slid along the rotational shaft when the rotational shaft is rotated.

### CROSS-REFERENCE(S) TO RELATED APPLICATIONS

The present invention claims priority of Korean Patent Application No. 10-2008-0117409, filed on Nov. 25, 2008, the contents of which are incorporated herein by reference.

### BACKGROUND OF THE INVENTION

1. Field of the Invention

The present invention relates to an apparatus for opening and closing a camera door, and particularly to an apparatus for opening and closing a camera door, which can automatically open and close a lens of a camera installed at a mobile phone and the like.

2. Description of Related Art

As a photograph and digital technology is developed, there has been released a mobile phone or PDA equipped with a camera in which an image formed through a lens is converted into electrical signal using an imaging device and converted again into digital data and then stores the digital data.

The camera is installed at a rear surface, or a front surface, or a side surface of the mobile phone or PDA, such that light is incident to a lens.

In an early model of the mobile phone or PDA, the lens is typically exposed to the outside. In this case, since a surface of the lens is frequently covered with dust or foreign substance, the lens may be damaged, or it may be not possible to obtain a clear image.

Therefore, in order to solve the problem, there has been developed a mobile phone or PDA equipped with a camera door.

Herein, as an opening and closing method of the camera door, there have been proposed a mechanical method in which the camera door is opened and closed by mechanical interlocking corresponding to a user's operation, and an automatic method in which the cameral door is automatically opened and closed according to specific conditions.

As examples of the automatic apparatus for opening and closing the camera door, there are known an apparatus for opening and closing a camera door of a folder type mobile phone disclosed in Korean Patent Laid-Open No. 2004-102482, and an apparatus for opening and closing a camera door of a folder type mobile phone disclosed in Korean Patent Laid-Open No. 2004-102483.

In Korean Patent Laid-Open No. 2004-102482, the camera door comprised of a single blade is automatically opened and closed using a solenoid, and in Korean Patent Laid-Open No. 2004-102483, the camera door comprised of two blades is automatically opened and closed using a driving motor.

### SUMMARY OF THE INVENTION

An embodiment of the present invention is directed to providing an apparatus for opening and closing a camera door, in which a rotational shaft is rotated by a driving part such as a motor, and the door engaged with the rotational shaft is moved linearly so as to open and close an opening portion formed at a front surface of the lens.

To achieve the object of the present invention, the present invention provides an apparatus for opening and closing a camera door, includes a base which is formed with an opening portion and disposed at a front surface of a lens; a rotational shaft; a driving part for rotating the rotational shaft; and a door of which one end encloses the rotational shaft so as to slide along the rotational shaft and thus to open and close the opening portion, wherein a male screw thread is formed on an outer surface of the rotational shaft, and a female screw thread is formed on an inner surface of other end of the door so as to be engaged with the male screw thread, and the door is slid along the rotational shaft when the rotational shaft is rotated.

Preferably, the rotational shaft is formed with first and second male screw threads, and the first and second male screw threads are formed to be rotated in opposite directions to each other, and the door comprises a first door of which one end encloses the first male screw thread, and a second door of which one end encloses the second male screw thread, and the first and second doors are moved in directions adjacent to or spaced apart from each other so as to open and close the opening portion.

Preferably, the driving part is a permanent magnet stepping motor.

### BRIEF DESCRIPTION OF THE DRAWINGS

FIG. 1 is a view showing an opening portion which is closed by an apparatus for opening and closing a camera door according to the present invention.

FIG. 2 is a view showing the opening portion which is opened by the apparatus for opening and closing the camera door according to the present invention.

### DESCRIPTION OF SPECIFIC EMBODIMENTS

The advantages, features and aspects of the invention will become apparent from the following description of the embodiments with reference to the accompanying drawings, which is set forth hereinafter.

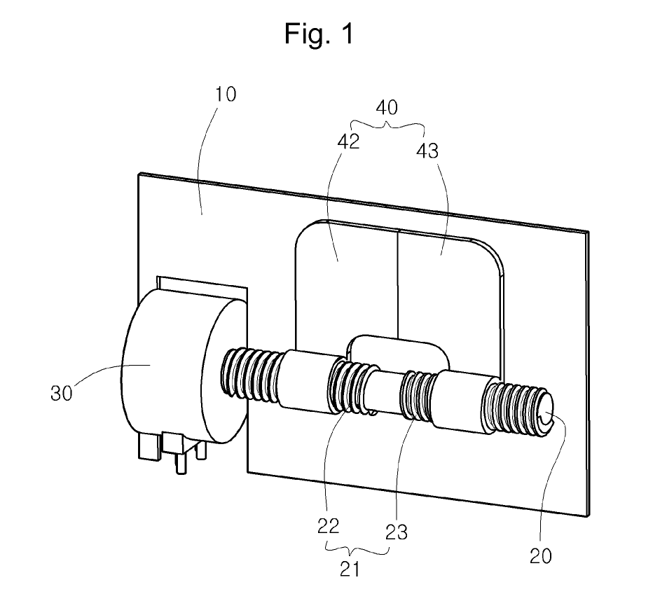

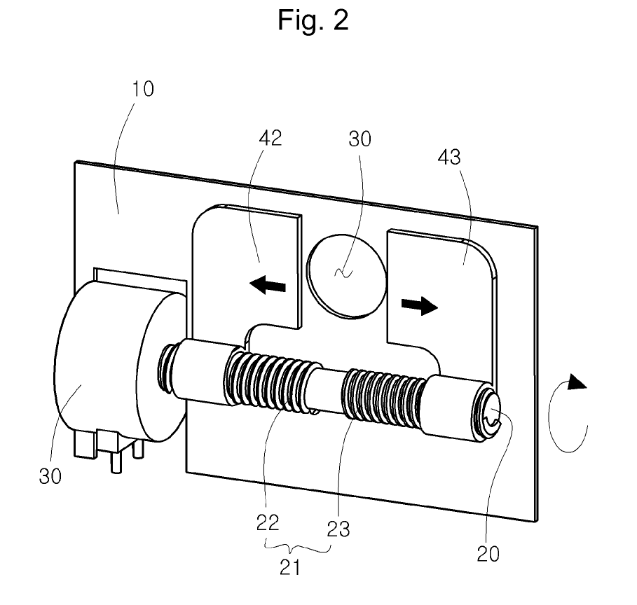

FIG. 1 is a view showing an opening portion which is closed by an apparatus for opening and closing a camera door according to the present invention, and FIG. 2 is a view showing the opening portion which is opened by the apparatus for opening and closing the camera door according to the present invention.

In the embodiment, the description is disclosed on the assumption that an apparatus for opening and closing a camera door of the present invention is installed at a mobile phone.

As shown in FIGS. 1 and 2, the apparatus for opening and closing the camera door includes a base 10, a rotational shaft 20, a driving part 30 and a door 40.

The base 10 may be an outer case of a mobile phone camera, or may be a separate member which is disposed outside of the mobile phone camera.

The base 10 is formed with an opening portion 12, and the opening portion 12 is disposed at a front surface of a camera lens so that the opening portion 12 and lens are aligned on the same line in an optical axis direction.

The rotational shaft 20 is disposed to be parallel with the base 10.

A Male screw thread 21 is formed on an outer surface of the rotational shaft 20.

The driving part 30 functions to rotate the rotational shaft 20 and includes a motor and the like.

Preferably, the driving part 30 is a permanent magnet stepping motor.

As described above, since the permanent magnet stepping motor is used as the driving part 30, it is prevented that the motor and rotational shaft 20 are rotated arbitrarily when power is not applied to the driving part 30.

Thus, it is also prevented that the door 40 engaged with the rotational shaft 20 is arbitrarily moved by rotation of the rotational shaft 20 and opens and closes the opening portion 12.

One end of the door 40 encloses the rotational shaft 20 and slides along the rotational shaft 20 so as to open and close the opening portion 12.

A female screw thread is formed at an inner surface of the end of the door 40 enclosing the rotational shaft 20 so as to be engaged with the male screw thread. When the rotational shaft 20 is rotated, the door 40 is linearly moved along the rotational shaft 20 by the male and female screw threads so as to open and close the opening portion 12.

At the other end of the door 40, there is provided a member like a guide rail for guiding the linear movement of the door 40.

That is, the other end of the door 40 is inserted into the guide rail. Thus when the rotational shaft 20 is rotated, the door 40 is not rotated together with the rotational shaft 20 by the guide rail, but linearly moved along the guide rail.

Only a single door 40 may be provided. However, it is preferable that two doors are provided.

That is, in case that the single door 40 is provided, a movement range of the door has to be increased in order to open and close the opening portion 1, and thus a rotational amount of the rotational shaft 20 is also increased.

As a result, the driving part 30 consumes large electricity in order to rotate the rotational shaft 20.

However, in case that the two doors 400 are provided, the movement range of each door for opening and closing the opening portion 12 is less than that of the single door, and thus the rotational amount of the rotational shaft 20 is also reduced.

Therefore, the power consumption of the driving part 30 for opening and closing the opening portion 12 is reduced, thereby reducing a power consumption of the mobile phone.

In case that the two doors 40 are provided as described above, the rotational shaft 20 had a first male screw thread 22 and a second male screw thread.

Herein, the first and second male screw threads 22 and 23 are formed to be rotated in opposite directions to each other.

And the door 40 includes a first door 42 of which one end encloses the first male screw thread 22, and second door 43 of which one end encloses the second male screw thread 23.

That is, a first female screw thread is formed at an inner surface of the end of the first door 42 so as to be engaged with the first male screw thread 22, and a second female screw thread is formed at an inner surface of the end of the second door 43 so as to be engaged with the second male screw thread 23.

When the rotational shaft 20 is rotated, as shown in FIG. 1, the first and second doors 42 and 43 are respectively moved in directions adjacent to each other so as to close the opening portion 12, or as shown in FIG. 2, moved in directions spaced part from each other so as to open the opening portion 12.

In other words, since the first and second male screw threads 22 and 23 are formed to be rotated in the opposite directions to each other, the first and second doors 42 and 43 are moved to be adjacent to or spaced apart from each other when the rotational shaft 20 is rotated.

Further, since the first and second male screw threads 22 and 23 are formed on the rotational shaft 20 to be rotated in the opposite directions to each other, a distance between the first and second doors 42 and 43 is rapidly adjusted by the rotation of the rotational shaft 20.

Therefore, the opening portion 12 can be rapidly opened and closed with a low power consumption.

The apparatus for opening and closing the camera door of the present invention can be applied to an electronic equipment such as a mobile phone. When the rotational shaft is rotated, the door engaged with the rotational shaft is linearly moved so that the opening portion disposed at the front surface of the lens is opened or closed.

According to the present invention as described above, since the door engaged with the rotational shaft is linearly moved so as to open and close the opening portion when the rotational shaft is rotated by the driving part such as a motor, it is possible to move the door with a simple structure.

Further, since the first and second male screw threads are formed on the rotational shaft, and the first and second doors are engaged with the first and second male screw threads, the first and second doors are moved to be adjacent to or spaced apart from each other by the rotation of the rotational shaft, and thus it is possible to facilely open and close the door with the low power consumption.

While the present invention has been described with respect to the specific embodiments, it will be apparent to those skilled in the art that various changes and modifications may be made without departing from the spirit and scope of the invention as defined in the following claims.

1. An apparatus for opening and closing a camera door, comprising:
a base which is formed with an opening portion and disposed at a front surface of a lens;
a rotational shaft;
a driving part for rotating the rotational shaft; and
a door of which one end encloses the rotational shaft so as to slide along the rotational shaft and thus to open and close the opening portion,
wherein a male screw thread is formed on an outer surface of the rotational shaft, and a female screw thread is formed on an inner surface of other end of the door so as to be engaged with the male screw thread, and the door is slid along the rotational shaft when the rotational shaft is rotated.

2. The apparatus of claim 1, wherein the rotational shaft is formed with first and second male screw threads, and the first and second male screw threads are formed to be rotated in opposite directions to each other, and
the door comprises a first door of which one end encloses the first male screw thread, and a second door of which one end encloses the second male screw thread, and
the first and second doors are moved in directions adjacent to or spaced apart from each other so as to open and close the opening portion.

3. The apparatus of claim 1, wherein the driving part is a permanent magnet stepping motor.

4. The apparatus of claim 2, wherein the driving part is a permanent magnet stepping motor.
